(19) United States
(12) Patent Application Publication
(10) Pub. No.: US 2020/0107694 A1
(43) Pub. Date: Apr. 9, 2020

(54) Glass Washing System

(71) Applicants: Derek James Kwong, San Francisco, CA (US); Kiran Gouravaram, Alameda, CA (US)

(72) Inventors: Derek James Kwong, San Francisco, CA (US); Kiran Gouravaram, Alameda, CA (US)

(21) Appl. No.: 16/593,707

(22) Filed: Oct. 4, 2019

Related U.S. Application Data
(60) Provisional application No. 62/741,378, filed on Oct. 4, 2018.

(51) Int. Cl. A47L 15/00; A47L 15/42; B08B 3/02

(52) U.S. Cl. CPC A47L 15/0065; A47L 15/0076; B08B 3/02; A47L 15/4214; A47L 15/0089

(57) ABSTRACT

A glass washing system is designed to spray water into a glass when activated. The washer has a cabinet, a pair of containers, a dispenser, a collection basin, and a pump. The cabinet acts as the central storage space and structural support for the remaining components of the washer. The pair of containers are used to separately store clean water and dirty water. The collection basin traverses into a countertop of the cabinet to prevent washing fluid from spilling into the surrounding areas. The dispenser is mounted within the basin and the pump is connected in between the clean water container and the dispenser so that water is sprayed into the glass when the user presses the glass over the dispenser. Water then drains out of the basin through the drain and is collected within the dirty water container.

The current application claims a priority to the U.S. Provisional Patent application Ser. No. 62/741,378 filed on Oct. 4, 2018.

### FIELD OF THE INVENTION

The present invention generally relates to tableware cleaning equipment. More specifically, the present invention is a portable glassware rinsing apparatus which may be used in various locations, even where consistent electrical power is not available.

### BACKGROUND OF THE INVENTION

Industrial dishwashing equipment is commonly used in restaurants or bars, to clean and sanitize tableware in a short amount of time. Commercial kitchens use high volume dishwashing equipment to increase the efficiency of the process especially when there is an increasing number of costumers, which require a high turn around rate. Ensuring the client is provided with clean and sanitized tableware is an essential step for any successful establishment. A common practice for glassware, is to rinse the glass before serving a customer, even if the glass has been cleaned previously. This practice is especially common when serving beer beverages. Most bars include a type of rinser into the equipment, which allows users to easily give the glass one last rinse before serving the costumer. Rinsing a glass before use has various purposes including but not limited to, removing any remnants of detergent or dust, and lowering the temperature of the glass. In addition, when a beer glass is rinsed it becomes more slippery, therefore the pour is more uniform, and as such a more enjoyable drinking experience. Traditional glass rinsers are integrated into the work surface of the bar, and most are permanently connected to the water supply and plumbing system. Problems arise for venues that organize outdoors events in locations where a water supply is not directly available. The present invention aims to solve some of these problems by disclosing a portable glass rinser which may be used by bartenders at various locations, ensuring the same quality of service is provided by the venue regardless of the location. As such, the present invention provides a self-contained system that enables the user to conveniently transport all necessary materials for rinsing a glass. Specifically, the present invention includes facilities for dispensing a quantity of clean water into the glass. Additionally, the present invention includes facilities for gathering and storing dirty water that has been used to rinse the glass. Further, the present invention includes a portable power supply that enables the rinser to operate with or without an external power source.

### BRIEF DESCRIPTION OF THE DRAWINGS

FIG. 1 is a perspective view of the present invention.

FIG. 2 is a front view of the present invention.

FIG. 3 is a left-side view of the present invention.

FIG. 4 is a right-side view of the present invention.

FIG. 5 is a front sectional view of the present invention taken along line 5-5 in FIG. 4. In this view bold arrows indicate the direction of flow and dashed lines showing water and a glass indicate environmental structure.

FIG. 6 is an exploded perspective view of the present invention.

FIG. 7 is a system diagram showing electrical connections between the components of the present invention.

### DETAIL DESCRIPTIONS OF THE INVENTION

All illustrations of the drawings are for the purpose of describing selected versions of the present invention and are not intended to limit the scope of the present invention.

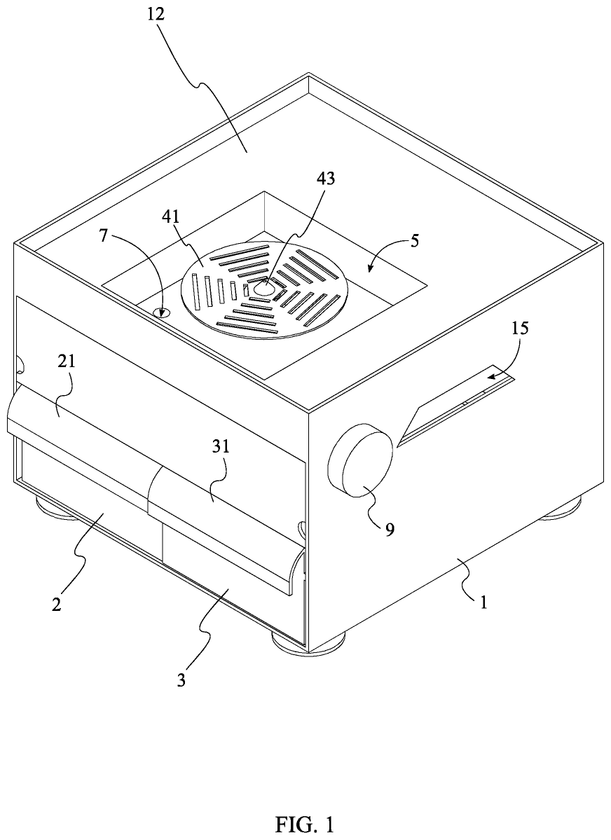

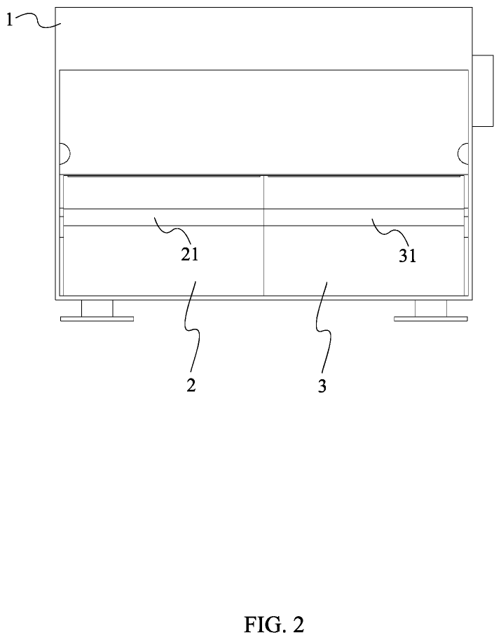

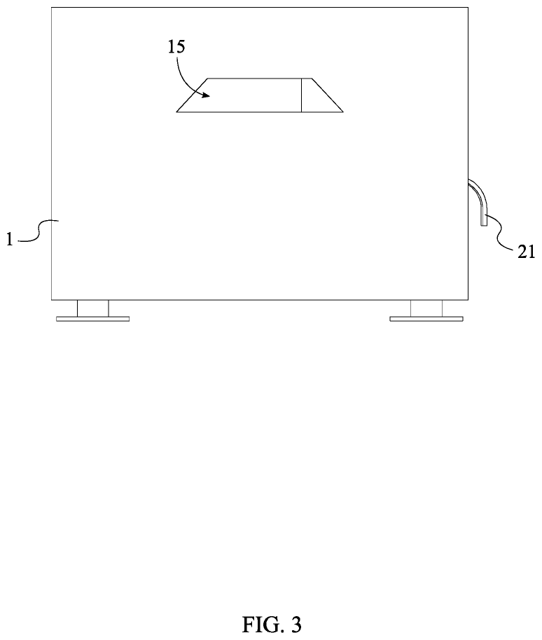

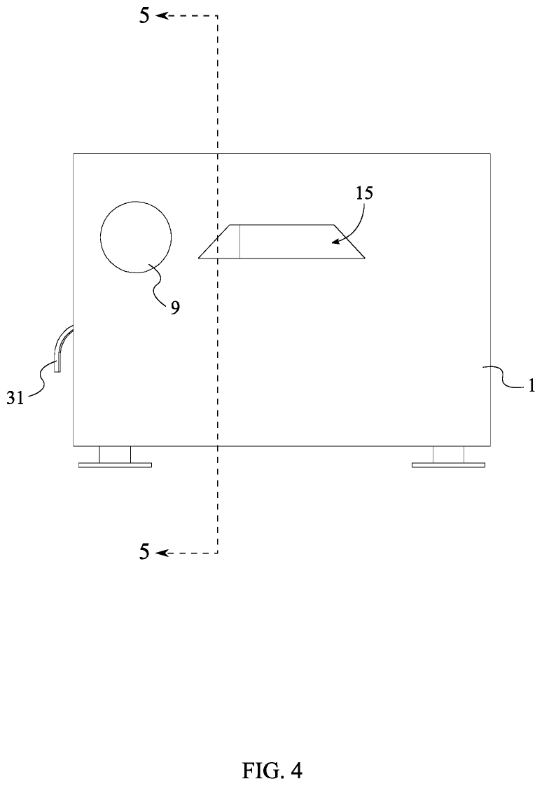

Referring to FIG. 1 through FIG. 7, the present invention, the glass washing system, is a device used to automatically clean the inside of a glass or any other type of container. To accomplish this, the present invention makes use of a user-activated pump to spray clean water into the glass. In the preferred embodiment of the present invention, a user is able to wash the inside of the glass by placing the rim of the glass over a nozzle and then activating the pump. The pump is preferably activated by a pressure sensitive switch. The water used to clean the inside of the glass is then drained into a storage container. Thus, the present invention provides a portable and self-contained bar accessory. To achieve the above-described functionalities, the present invention comprises a cabinet 1, a first container 2, a second container 3, a dispenser 4, a collection basin 5, a pump 6, and a drain 7. The cabinet 1 functions as the overall support structure of the invention. As such, the first container 2 and the second container 3 are mounted within an interior compartment 11 of the cabinet 1. Additionally, the second container 3 is positioned offset from the first container 2 across the interior compartment 11. As a result, the first container 2 and the second container 3 are housed within the cabinet 1 and positioned to function as receptacles for clean water and dirty water, respectively. That is, the first container 2 is intended to be a reservoir of clean water, or any other type of fluid, that is used to wash the inside of the glass. Likewise, the second container 3 is used as a receptacle for dirty water, or any other type of fluid, that has been used to wash the glass. The collection basin 5 normally traverses into a countertop 12 of the cabinet 1. Thus, forming a temporary receptacle for dirty water that has been used to wash the glass. The dispenser 4 is a device used to spray water into the glass. Additionally, the dispenser 4 is mounted within the collection basin 5 so that the water used to clean the glass is able to fall into the collection basin 5 and does not splash into the surrounding area Preferably, the dispenser 4 discharges water into the glass when the user presses the rim of the glass onto the dispenser 4. The drain 7 is integrated into the collection basin 5 and forms the outlet for dirty water. Additionally, the collection basin 5 is in fluid communication with the second container 3 through the drain 7. Consequently, dirty water that gathers in the collection basin 5 is able to flow into the second container 3 for storage. The pump 6 is mounted within the interior compartment 11. Additionally, the first container 2 is in fluid communication with the dispenser 4, through the pump 6. As a result, the pump 6 is able to transfer water out of the first container 2 to the dispenser 4. The dispenser 4 then sprays the water into the glass before the water falls into the collection basin 5 and is stored in the second container 3. This configuration enables the present invention to function as a self-contained and portable device. Preferably a plurality of handles 15 is laterally mounted onto the cabinet 1 so that the user can easily transport or reposition the present invention.

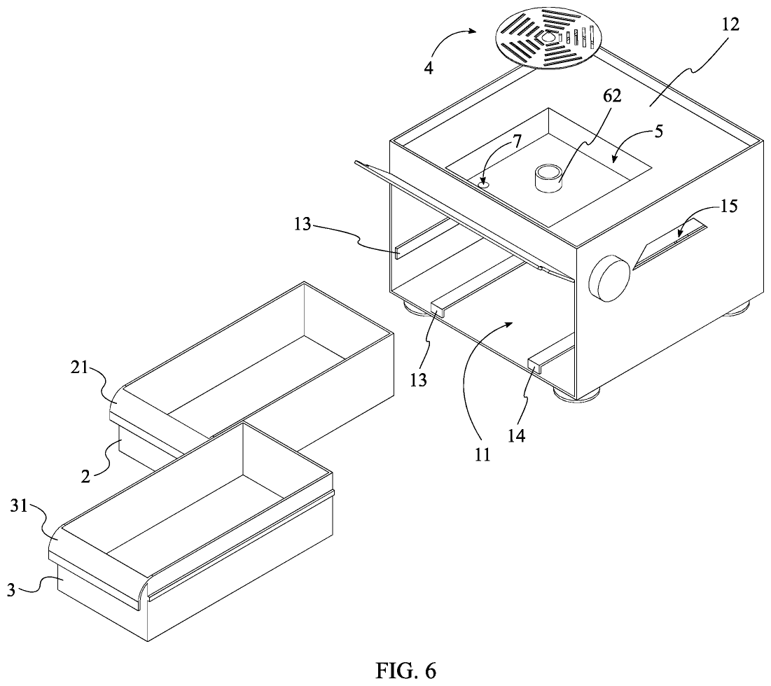

Referring to FIG. 1 and FIG. 6, preferably, the first container 2 and the second container 3 are designed to be removed and refilled or emptied. Further, the first container 2 and the second container 3 are designed to function as drawers for the cabinet 1. To accomplish this, the present invention further comprises a first slide rail assembly 13, and a second slide rail assembly 14. The first slide rail assembly 13 is connected in between the first container 2 and the cabinet 1. Accordingly, the first slide rail assembly 13 enables the first container 2 to be slid out of the interior compartment 11 as desired. Similarly, the second slide rail assembly 14 is connected in between the second container 3 and the cabinet 1. Accordingly, the second slide rail assembly 14 enables the second container 3 to be slid out of the interior compartment 11 as desired. Preferably, the first container 2 and the second container 3 are positioned side by side. Preferably a pair of slide rails are interposed in between the first container 2 and the second container 3. Thus positioned, the pair of slide rails prevent the first container 2 from rubbing against the second container 3. Additionally, the present invention comprises a first container handle 21 and a second container handle 31. The first container handle 21 is laterally mounted onto the first container 2. The second container handle 31 is laterally mounted onto the second container 3. Accordingly, the user can easily slide the first container 2 and the second container 3 into or out of the interior compartment 11 independently. Some embodiments are designed with decorative panels that are mounted onto the first container 2 and the second container 3 to add aesthetic appeal.

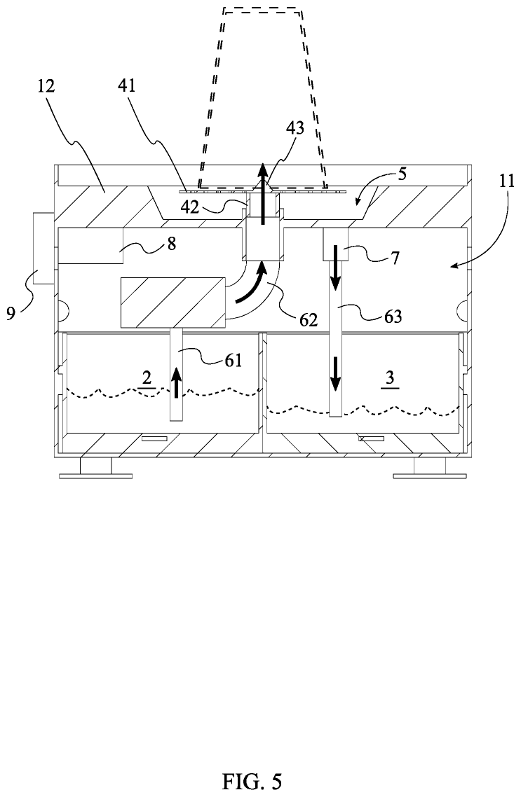

Referring to FIG. 5 and FIG. 6, the present invention is designed to move fluids through the system without leakage. To that end, the present invention further comprises a clean water tube 61, a fluid transfer tube 62, and a dirty water tube 63. The clean water tube 61 is connected in between the first container 2 and an inlet of the pump 6. Further, the first container 2 is in fluid communication with the pump 6 through the clean water tube 61 and the inlet. As a result, the pump 6 is able to draw water out of the first container 2 through the clean water tube 61. The fluid transfer tube 62 is connected in between an outlet of the pump 6 and the dispenser 4. Additionally, the pump 6 is in fluid communication with the dispenser 4 through the outlet and the fluid transfer tube 62. Thus connected, the fluid transfer tube 62 forms the last channel that water travels through before being disbursed by the dispenser 4. The dirty water tube 63 is connected in between the drain 7 and the second container 3. Additionally, the collection basin 5 is in fluid communication with the second container 3 through the drain 7 and the dirty water tube 63. As a result, dirty water is able to drain into the second container 3 for storage. In some embodiments of the present invention, one end of the clean water tube 61 is attached to a spout of the first container 2 so that the clean water stored therein cannot spill into the surrounding area, even when the first container 2 is upended. Similarly, in some embodiments of the present invention, one end of the dirty water tube 63 is attached to a spout of the second container 3 so that the dirty water stored therein cannot spill into the surrounding area, even when the second container 3 is upended.

Referring to FIG. 5 and FIG. 6, the dispenser 4 is designed to spray clean water into the glass without letting dirty water collect on the surface of the glass. To accomplish this, the dispenser 4 comprises a grate 41, a nozzle 43, an activation switch 42, a control circuit 8, and a human input device (HID) 9. The grate 41 is mounted within the collection basin 5 so that water sprayed into the glass can fall into the collection basin 5. The nozzle 43 is mounted adjacent to the grate 41, opposite to the collection basin 5. Accordingly, the nozzle 43 is positioned to facilitate spraying clean water into the glass. Preferably, the user is able to press down on, and therefore linearly displace the grate 41, when dispensing clean water. To that end, the nozzle 43 is in fluid communication with an outlet of the pump 6 so that water can be transferred out of the first container 2 and into the glass. Preferably, the primary activation switch 42 is a pushbutton switch that is integrated into the grate 41 and operatively coupled to the pump 6. Specifically, the activation switch 42 transitions the pump 6 between an active state and an inactive state when the user interacts with the grate 41. As a result, the activation switch 42 is able to signal the pump 6 to transfer water out of the first container 2 and through the nozzle 43 when the user presses the rim of the glass onto the grate 41 and displaces the grate 41. Additionally, the activation switch 42 provides a counterforce that moves the grate 41 into a starting position whenever an external force is applied. Preferably, the activation switch 42 includes a spring-loaded support structure that is connected in between the grate 41 and the collection basin 5.

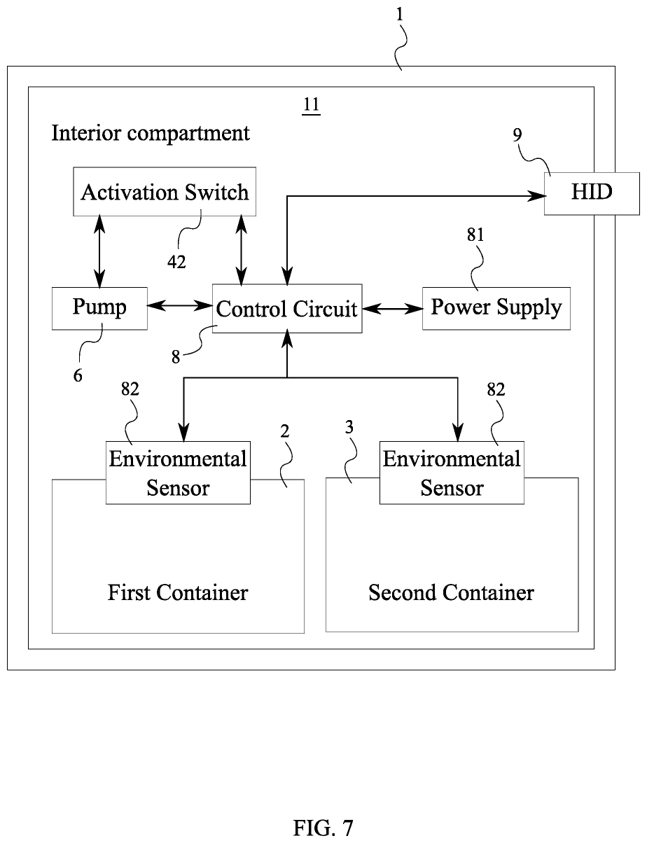

Referring to FIG. 5 and FIG. 7, in some embodiments of the activation switch 42 is electronically connected to the pump 6 so that the activation switch 42 is able to electronically control the operations of the pump 6. Separate embodiments of the activation switch 42 are mechanically coupled between the pump 6 and the nozzle 43 so that depressing the grate 41 releases a mechanical switch that permits the flow of water from the pump 6 through the nozzle 43. The control circuit 8 is a computing device designed to interface with external systems as well as receive and execute commands that govern the function of any connected electrical device. The control circuit 8 is housed within the cabinet 1 so that the control circuit 8 is shielded from hazards in the external environment. The HID 9 is laterally mounted onto the cabinet 1 and electronically connected to the control circuit 8. Accordingly, the HID 9 is positioned to facilitate relaying information between the user and the control circuit 8. In some embodiments the user is able to governs the operation of the pump 6 by interacting with the HID 9. For example, the user is able to adjust the pressure of the clean water stream by interacting with the HID 9.

Preferably, the present invention further comprises a power supply 81. The power supply 81 is mounted within the interior compartment 11. Additionally, the power supply 81 is positioned offset from the first container 2 and the second container 3. As a result, the power supply 81 is isolated from the external environment and protected from any leaks that may occur. The power supply 81 is electrically coupled to the pump 6 the dispenser 4, and the control circuit 8. Accordingly, the power supply 81 is capable of satisfying the electrical power requirements for the electrical components of the present invention. Preferably, the power supply 81 is a rechargeable battery. Further, the power supply 81 is equipped with an external device interface that enables the power supply 81 and control circuit 8 to be electrically and communicably coupled to an external source of power. In some embodiments the power supply is equipped with a power cord for connecting to standard wall outlets. The present invention is designed to be coupled to an external control system capable of monitoring overall system functioning. Some embodiments of the present invention further comprise a plurality of environmental sensors 82 that is distributed throughout the interior compartment 11 and used to monitor the amount of fluid within the first container 2 and the second container 3. The plurality of environmental sensors 82 is electronically coupled to the control circuit 8. Thus, the control circuit 8 is able to alert the user when fluids need to be emptied or refilled. Although the invention has been explained in relation to its preferred embodiment, it is to be understood that many other possible modifications and variations can be made without departing from the spirit and scope of the invention as hereinafter claimed.

What is claimed is:

1. A glass washing system comprising:
a cabinet;
a first container;
a second container;
a dispenser;
a collection basin;
a pump;
a drain;
the first container being mounted within an interior compartment of the cabinet;
the second container being mounted within the interior compartment;
the second container being positioned offset from the first container, across the interior compartment;
the collection basin normally traversing into a countertop of the cabinet;
the dispenser being mounted within the collection basin;
the pump being mounted within the interior compartment;
the first container being in fluid communication with the dispenser, through the pump;
the drain being integrated into the collection basin; and
the collection basin being in fluid communication with the second container through the drain.

2. The glass washing system as claimed in claim 1 comprising:
a first slide rail assembly; and
the first slide rail assembly being connected in between the first container and the cabinet.

3. The glass washing system as claimed in claim 1 comprising:
a second slide rail assembly; and
the second slide rail assembly being connected in between the second container and the cabinet.

4. The glass washing system as claimed in claim 1 comprising:
a clean water tube;
the clean water tube being connected in between the first container and an inlet of the pump; and
the first container being in fluid communication with the pump through the clean water tube and the inlet.

5. The glass washing system as claimed in claim 1 comprising:
a fluid transfer tube;
the fluid transfer tube being connected in between an outlet of the pump and the dispenser; and
the pump being in fluid communication with the dispenser through the outlet and the fluid transfer tube.

6. The glass washing system as claimed in claim 1 comprising:
a dirty water tube; and
the dirty water tube being connected in between the drain and the second container.

7. The glass washing system as claimed in claim 1 comprising:
the dispenser comprising a grate, a nozzle, and an activation switch;
the grate being mounted within the collection basin;
the nozzle being mounted adjacent to the grate, opposite to the collection basin;
the nozzle being in fluid communication with an outlet of the pump;
the primary activation switch being integrated into the grate; and
the primary activation switch being operatively coupled to the pump, wherein the activation switch transitions the pump between an active state and an inactive state.

8. The glass washing system as claimed in claim 1 comprising:
a plurality of primary handles; and
the plurality of handles being laterally mounted onto the cabinet.

9. The glass washing system as claimed in claim 1 comprising:
a first container handle; and
the first container handle being laterally mounted onto the first container handle.

10. The glass washing system as claimed in claim 1 comprising:
a second container handle; and
the second container handle being laterally mounted onto the second container handle.

11. The glass washing system as claimed in claim 1 comprising:
a control circuit;
a human input device (HID);
the control circuit being housed within the cabinet;
the HID being laterally integrated into the cabinet; and
the HID and the pump being electronically connected to the control circuit.

12. The glass washing system as claimed in claim 11 comprising:
a plurality of environmental sensors;
the plurality of environmental sensors being distributed within the interior compartment; and
the plurality of environmental sensors being electronically connected to the control circuit.

13. The glass washing system as claimed in claim 1 comprising:
a power supply;
the power supply being mounted within the interior compartment;
the power supply being positioned offset from the first container and the second container, across the interior compartment; and
the power supply being electrically connected to the pump and the dispenser.
